(19) United States
(12) Patent Application Publication
(10) Pub. No.: US 2016/0344271 A1
(43) Pub. Date: Nov. 24, 2016

(54) Single Phase Brushless Motor and Electric Apparatus Having the Same

(71) Applicant: Johnson Electric S.A., Murten (CH)

(72) Inventors: Yue Li, Hong Kong (CN); Chui You Zhou, Shenzhen (CN); Gang Li, Shenzhen (CN); Yong Wang, Shenzhen (CN); Yong Li, Shenzhen (CN); Wei Zhang, Shenzhen (CN); Ming Chen, Shenzhen (CN); Jie Chai, Shenzhen (CN); Hong Liang Yi, Shenzhen (CN); Tao Zhang, Shenzhen (CN)

(21) Appl. No.: 15/160,174

(22) Filed: May 20, 2016

(30) Foreign Application Priority Data
May 21, 2015 (CN) 201510262232.9
Apr. 8, 2016 (CN) 201610219185.4

(51) Int. Cl. H02K 21/02; B25F 5/00; B60J 1/20; H02K 1/14; H02K 1/27

(52) U.S. Cl. CPC H02K 21/025; H02K 1/14; H02K 1/2706; B60J 1/20; B25F 5/00

(57) ABSTRACT

A single phase brushless motor and a power tool and a car window lifer employing the motor are provided. The motor includes a stator and a rotor. The stator includes a stator core and windings. The stator core includes a yoke and teeth extending inward from the yoke. The tooth includes a tooth tip. The tooth tip includes a first pole shoe and a second pole shoe. The tooth tip forms a positioning groove facing the rotor between the first and second pole shoes. The rotor is received in a space defined between the first and second pole shoes. The rotor comprises multiple permanent magnetic poles arranged in a circumferential direction of the rotor. The first and second pole shoes are symmetrical about a central line of the tooth body, such that the rotor startup capability in one direction is greater than the rotor startup capability in an opposite direction.

### CROSS REFERENCE TO RELATED APPLICATIONS

This non-provisional patent application claims priority under 35 U.S.C. §119(a) from Patent Application No. 201510262232.9 filed in The People's Republic of China on 21 May, 2015, and Patent Application No. 201610219185.4 filed in The People's Republic of China on 8 Apr. 2016.

### FIELD OF THE INVENTION

The present invention relates to motors, and in particular to a single phase permanent magnetic brushless motor and an electric apparatus employing the same.

### BACKGROUND OF THE INVENTION

Single phase motors have the advantages of low cost. However, if the rotor stops at a position where an angle between a direction of the magnetic pole of the rotor and a direction of the stator pole is too small, the rotation torque applied to the rotor at the moment of starting the rotor will be small. If the rotation torque is equal to or less than the frictional torque, the motor cannot be started. This is commonly referred to as startup failure. How to avoid the startup failure of the single phase motor is an issue to be urgently addressed.

### SUMMARY OF THE INVENTION

Thus, there is a desire for a single phase brushless motor which can overcome the above shortcomings.

In one aspect, a single phase brushless motor is provided which includes a stator and a rotor rotatable relative to the stator. The stator includes a stator core and windings. The stator core includes a yoke and at least two teeth extending inward from the yoke. The tooth includes a tooth body and a tooth tip disposed at a distal end of the tooth body. The windings are wound around the stator core. The tooth tip comprises a first pole shoe and a second pole shoe located at opposite two sides of the tooth, respectively. The tooth tip forms a positioning groove facing the rotor. The rotor is received in a space defined between the first pole shoes and the second pole shoes of the teeth. The rotor comprises a plurality of permanent magnetic poles arranged in a circumferential direction of the rotor. The first pole shoe and the second pole shoe are symmetrical about a central line of the tooth body, such that startup capability of the rotor in one direction is greater than startup capability of the rotor in an opposite direction.

Preferably, a pole face of the second pole shoe facing the rotor is greater than a pole face of the first pole shoe facing the rotor.

Preferably, inner circumferential surfaces of the first pole shoe and the second pole shoe are located on a same cylindrical surface.

Preferably, in the at least two teeth, the second pole shoe of one tooth and the first pole shoe of another tooth are disposed adjacent each other with a slot opening or a magnetic bridge with a large magnetic reluctance formed therebetween.

Preferably, inner circumferential surfaces of the first pole shoe and the second pole shoe and the rotor define a gap therebetween, and the width of the slot opening is greater than a thickness of the gap but less than a width of the positioning groove.

Preferably, in a startup phase, a ratio of an average output torque of the rotor in the one direction to an average output torque of the rotor in the opposite direction is greater than 11:9.

Preferably, a central line of the positioning groove is coincident with a central line of the tooth body.

Preferably, a width of the positioning groove is equal to or greater than a width of the tooth body of the tooth.

Preferably, a length of the second pole shoe is greater than a length of the first pole shoe but less than two times of the length of the first pole shoe.

Preferably, a radial thickness of the first pole shoe and the second pole shoe gradually decreases in a direction away from the tooth.

Preferably, the yoke comprises a half-frame shaped yoke, a closed frame-shaped yoke or an annular yoke.

Preferably, the rotor further includes a rotor core, and the permanent magnetic poles are formed by a permanent magnet mounted to a surface of the rotor core or permanent magnets embedded in the rotor core.

Preferably, a startup angle of the rotor is an electric angle greater than 40 degrees.

In another aspect, an electric apparatus such as a power tool or a vehicle window lifter is provided which includes the above single phase brushless motor.

In comparison with the prior art, the above embodiments of the present invention have the following advantages: the tooth tip of the stator forms the positioning groove such that the rotor can stop at a position deviating from the dead point; the provision of the asymmetric pole shoes with different sizes makes the rotor have different bidirectional startup capabilities, which is especially suitable for applications having different requirements for bidirectional startup capabilities, such as power tools and vehicle window lifters.

### BRIEF DESCRIPTION OF THE DRAWINGS

FIG. 1 is a simplified schematic view of a single phase brushless motor according to one embodiment of the present invention.

FIG. 2 is a plane view of the single phase brushless motor of FIG. 1.

FIG. 3 is a top view of the stator core of the single phase brushless motor of FIG. 1.

FIG. 4 illustrates magnetic flux distribution of the single phase brushless motor of FIG. 1.

FIG. 5 is a graph showing the change of back electromotive force value and positioning groove angle of the single phase brushless motor of FIG. 1 during operation.

FIG. 6 is a plane view of a rotor of the single phase brushless motor according to one embodiment of the present invention.

FIG. 7 is an exploded view of a single phase brushless motor according to one embodiment of the present invention.

FIG. 8 is a side view of a single phase brushless motor according to another one embodiment of the present invention.

### DETAILED DESCRIPTION OF THE PREFERRED EMBODIMENTS

Below, the present invention will be described further in conjunction with embodiments illustrated in the drawings.

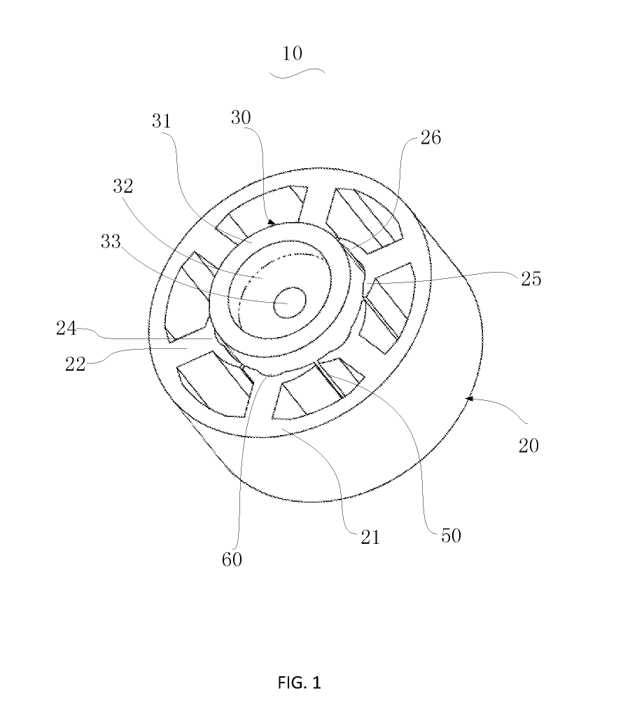

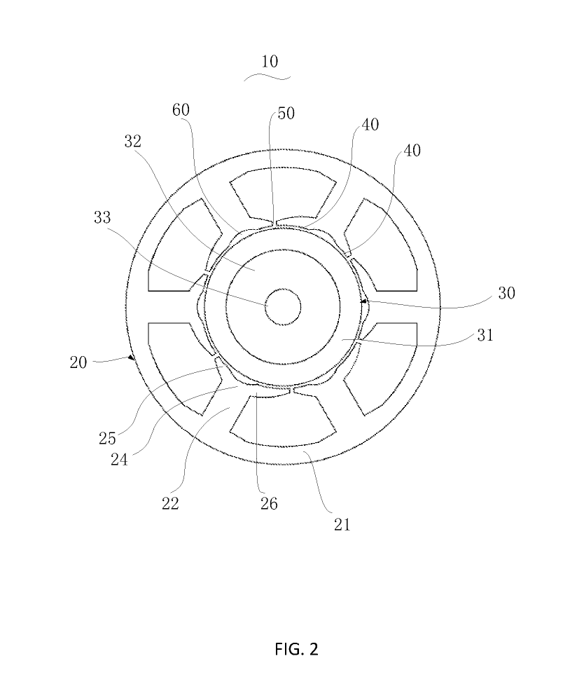

Referring to FIG. 1 and FIG. 2, a single phase brushless motor 10 in accordance with one embodiment of the present invention includes a stator 20 and a rotor 30 rotatable relative to the stator 20.

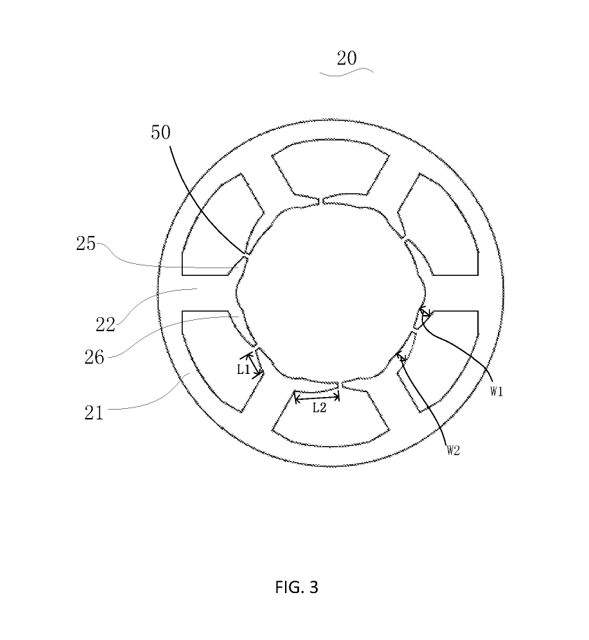

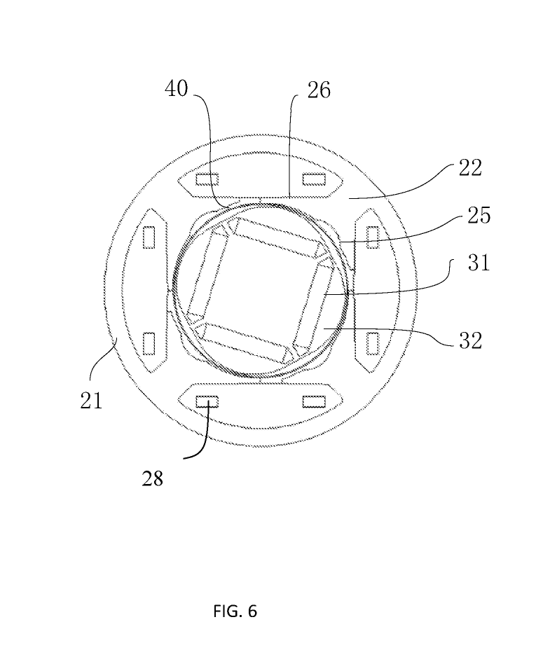

The stator 20 includes a stator core and windings 28 (FIG. 6). The stator core is made of a magnetic-conductive material such as silicon steel. The stator core includes a yoke 21 and at least two teeth 22 extending inward from the yoke 21. The teeth 22 are spacingly arranged along a circumferential direction of the yoke 21. The number of the teeth 22 may be determined according actual requirements. Each tooth 22 forms a tooth tip 24 at a distal end of the tooth 22. The windings are wound around the stator core. In this embodiment, the windings 28 may be wound around tooth bodies (located between the yoke 21 and the tooth tips 24) of the teeth 22. The tooth tip 24 includes a first pole shoe 25 and a second pole shoe 26 extending toward two sides of the tooth, respectively. Preferably, as shown in FIG. 3, the first pole shoe 25 has a length indicated by L1, the second pole shoe 26 has a length indicated by L2, and the length L2 of the second pole shoe 26 is greater than the length L1 of the first pole shoe 25. Therefore, a pole face of the second pole shoe 26 facing the rotor 30 is greater in size than a pole face of the first pole shoe 25 facing the rotor 30. Preferably, L2 is less than two times of L1.

The rotor 30 is received in a space defined by the first pole shoes 25 and second pole shoes 26 of the at least two teeth 22. The rotor 30 includes a plurality of permanent magnetic poles 31 arranged along a circumferential direction of the rotor 30. Preferably, inner circumferential surfaces of the first pole shoe 25 and the second pole shoe 26 are located on a same cylindrical surface. In the present embodiment, the inner circumferential surfaces of both the first pole shoe 25 and the second pole shoe 26 are concentric with outer circumferential surfaces of the permanent magnetic poles 31. In particular, the inner circumferential surfaces of the first pole shoe 25 and the second pole shoe 26 are located on a same cylindrical surface centered at the center of the rotor, and the permanent magnetic poles 31 are located on another cylindrical surface centered at the center of the rotor. That is, the inner circumferential surfaces of the first pole shoe 25 and the second pole shoe 26 are concentric with the outer circumferential surfaces of the permanent magnetic poles 31, such that the inner circumferential surfaces of the first pole shoe 25 and the second pole shoe 26 and the rotor 30 form an even gap 40 there between, which reduces the vibration and noise, makes the motor 10 operation smoother, and enhances the startup stability of the motor.

In this embodiment, in the at least two teeth 22, the second pole shoe 26 of one tooth 22 and the first pole shoe 25 of another tooth 22 are disposed adjacent each other with a slot opening 50 formed there between. The slot opening 50 has a relative large magnetic reluctance to prevent magnetic leakage between the second pole shoe 26 and the first pole shoe 25 at two sides of the slot opening 50 and increase a cogging torque of the motor. It is to be understood that a magnetic bridge with greater magnetic reluctance can be used to replace the slot opening 50. Because the first pole shoe 25 and the second pole shoe 26 have different lengths, the position of the slot opening 50/magnetic bridge deviates from a middle line between the tooth bodies of two adjacent teeth 22. That is, the slot opening 50 is closer to the tooth body of one of two adjacent teeth and away from the tooth body of the other of the two adjacent teeth.

Preferably, as shown in FIG. 3, a radial thickness W1 of the first pole shoe 25 gradually decreases along a direction away from the tooth body, and a radial thickness W2 of the second pole shoe 26 gradually decreases along a direction away from the tooth body. That is, the first pole shoe 25 and the second pole shoe 26 have a greater magnetic reluctance at a position closer to the slot opening 50, such that the magnetic reluctance of the first pole shoe 25 and the second pole shoe 26 gradually increases in a direction from the tooth body toward the slot opening 50, which improves the waveform of the air gap magnetic field to make the waveform smoother.

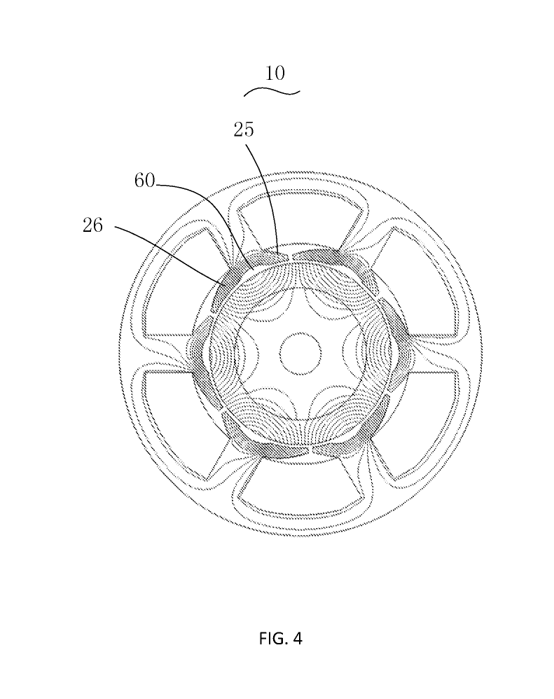

In this embodiment, the tooth 22 forms a positioning groove 60 facing the rotor 30 between the first pole shoe 25 and the second pole shoe 26. The positioning groove 60 preferably has an arc-shaped cross section. A central line of the positioning groove 60 is coincident with a central line of the tooth body, i.e. the positioning groove 60 deviates from a center of the tooth tip 24 of the tooth 22. The positioning groove 60 and the asymmetric pole shoes are configured and designed to control a stop position (i.e. an initial position) of the rotor 30 to deviate from a dead point position. The dead point position means a position where the center of the rotor magnetic pole is aligned with the center of the stator pole, i.e., the center of the pole face of the teeth 22 in the embodiment. In particular, when the rotor 30 stops, a circumferential center of the permanent magnetic pole is disposed as close to the pole face of the second pole shoe 26 as possible, preventing the rotor 30 from stopping at the dead point position. Preferably, in this embodiment, the stop position of the rotor 30 deviates from the dead point by an electric angle of more than 40 degrees. Under the condition that the stop position of the rotor 30 deviates from the dead point by an electric angle of more than 40 degrees, the magnetic torque applied to the rotor 30 at the moment of startup is increased, which increases the reliability of the motor 10 startup. Prior to energization of the windings of the stator 20, referring to FIG. 4, the magnetic saturation extent of the second pole shoe 26 is greater than the magnetic saturation extent of the first pole shoe 25 due to inductance differences between the first and second pole shoes 25, 26. Therefore, at the moment of energization of the windings of the stator 20, rotation of the rotor 30 in one direction will balance the difference of the magnetic saturation extent between the first and second pole shoes 25, 26 (i.e. the capability of starting toward the one direction is relative strong/big/high), while rotation of the rotor 30 in the other direction will increase the difference of the magnetic saturation extent between the first and second pole shoes 25, 26 (the capability of starting in the other direction is relative weak/small/low). That is, the capability of starting the rotor in one direction is stronger/bigger/higher than the capability of starting the rotor in the other direction. A controller connected with the windings can be used to control the direction of the current flowing through the windings of the stator 20, thus controlling the startup direction of the rotor 30. Preferably, at the startup phase, a ratio of an average output torque of the rotor 30 starting in one direction to the average output torque of the rotor 30 starting in the other direction is greater than 11:9.

In this embodiment, a circumferential width of the positioning groove 60 is substantially equal to a circumferential width of the tooth 22. In an alternative embodiment, the circumferential width of the positioning groove 60 may be less than or greater than the circumferential width of the tooth 22. Preferably, a width of the slot opening 50 is less than the width of the positioning groove 60 to prevent sudden change of the magnetic reluctance between two adjacent teeth 22 due to the provision of the slot opening 50, which improves the waveform of the air gap magnetic field to make the waveform smoother.

In this embodiment, the motor is a single-phase brushless direct current motor.

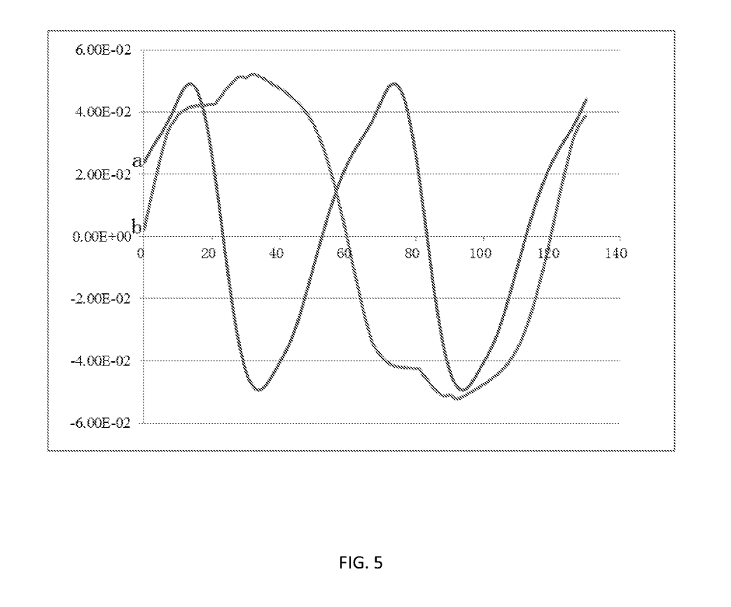

FIG. 5 is a graph showing curves of back electromotive force value and cogging torque of the above single phase brushless direct current motor 10 during operation. Curve a shows the change of the cogging torque, with the horizontal ordinate being rotor angle values and the vertical ordinate being the torque values. Curve b shows the change of the back electromotive force value, with the horizontal ordinate being the rotor angle values and the vertical ordinate being the back electromotive force values. As can be seen from the above graph, both the cogging torque and the back electromotive force curves change smoothly, which indicates that the operation of the motor 10 is stable. In addition, because of the provision of the positioning groove 60 and the asymmetric pole shoes, a zero-crossing point of the back electromotive force and the “dead point” of the rotor do not overlap, which can prevent failure of producing the startup torque caused by the rotor 30 stopping at the “dead point”. The “dead point” here corresponds to the zero point of the rising edge of the cogging torque curve a. Furthermore, a maximum value of the back electromotive force appears at a position close to the initial position of the rotor which corresponds to the zero point of the failing edge of the cogging torque curve a, such that the rotor can be driven by a greater startup torque at the moment of the startup, which increases the startup reliability of the motor.

Referring to FIG. 1 and FIG. 2, in one embodiment of the present invention, the rotor 30 further includes a rotor core 32. The rotor core 32 has a mounting hole 33 at a center thereof for fixedly mounting to a rotary shaft (not shown). The permanent magnetic poles 31 are formed by a permanent magnet mounted to a surface of the rotor core 32. Preferably, the permanent magnet is an annular permanent magnet. An outer circumferential surface of the rotor core 32 matches with the annular permanent magnet in shape, the annular permanent magnet surrounds the outer circumferential surface of the rotor core 32, the outer circumferential surface of the rotor core 32 is located on a circle centered at the center of the rotor, and the outer circumferential surface of the rotor core 32 is concentric with the outer circumferential surface of the annular permanent magnet. The rotary shaft is mounted in the mounting hole 33 at the center of the rotor, such that the rotor 30 is rotatable relative to the stator 20. It is to be understood that the present invention is not limited to the use of the annular permanent magnet. For example, multiple arc or straight permanent magnets may be mounted to the outer circumferential surface of the rotor core 32 to form the permanent magnetic poles 31 of the rotor 30.

Referring to FIG. 6, in another embodiment of the present invention, different from the embodiment described above, the multiple permanent magnets of the rotor 30 are formed by a plurality of permanent magnets embedded in an interior of the rotor core 32. In addition, in this embodiment, a distance between the inner circumferential surfaces of the first pole shoe 25 and second pole shoe 26 of the tooth of the stator 20 and the center of the rotor gradually increases in a direction closing to the central line of the tooth body, and an outer diameter of the rotor core 32 gradually decreases from a circumferential center to two circumferential ends of each permanent magnetic pole 31. Preferably, the peripheral portion of the rotor core 32 located outside of the permanent magnetic pole 31 is symmetrical about a circumferential central line of the permanent magnetic pole 31. Therefore, a gap 40 formed between the rotor 30 and the pole surfaces of the pole shoes of the tooth 22 of the stator has an uneven thickness.

In the above embodiments, the yoke 21 of the stator core is a closed annular shape. It is to be understood that the yoke 21 of the stator core 21 may also be a closed frame shape, such as a square or rectangular shape.

In the above embodiments, the stator tooth is of a salient type, i.e. the pole shoes extend beyond two sides of the tooth body in the circumferential direction.

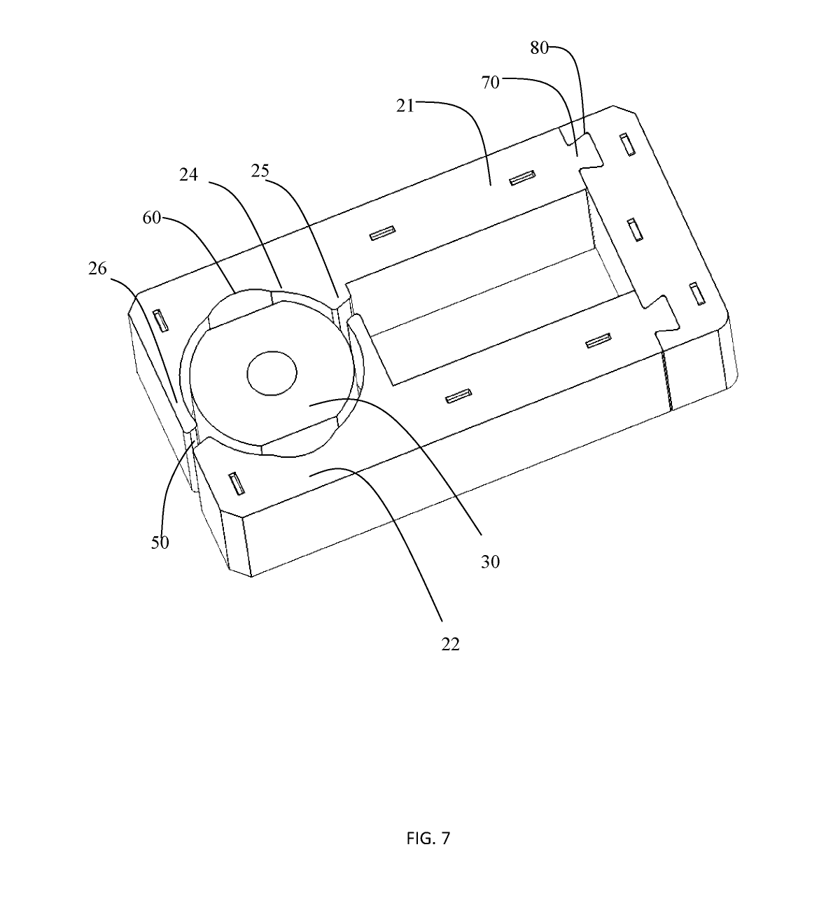

Referring to FIG. 7, in another embodiment of the present invention, the yoke 21 of the stator core is of an opened frame shape, such as U shape or C shape. At least two teeth 22 extend from the yoke 21. The tooth 22 includes a tooth tip 24 at a distal end thereof. The tooth tip 24 includes a first pole shoe 25 and a second pole shoe 26 extending toward two sides of the tooth, respectively. The rotor 30 is received in a space defined between the first pole shoes 25 and second pole shoes 26 of the at least two teeth 22. The stator core may be integrally formed, or may include several pieces separately formed and then assembled, e.g. by soldering or through mechanical connection. In this embodiment, the stator core includes three pieces that are assembled by dovetail joints. That is, one piece forms a dovetail groove 80, and each of the other two pieces forms a dovetail tongue 70 at an end thereof, corresponding to the dovetail groove 80, and the dovetail tongue 70 and the dovetail groove 80 are connected to form the dovetail joint. In this embodiment, the stator tooth 22 is of a non-salient type, i.e. the pole shoes do not extend outward from two sides of the tooth body, but rather are hidden at the end of the tooth body. In this embodiment, the permanent magnetic poles of the rotor may be directly fixed to the rotary shaft, thus eliminating the rotor core.

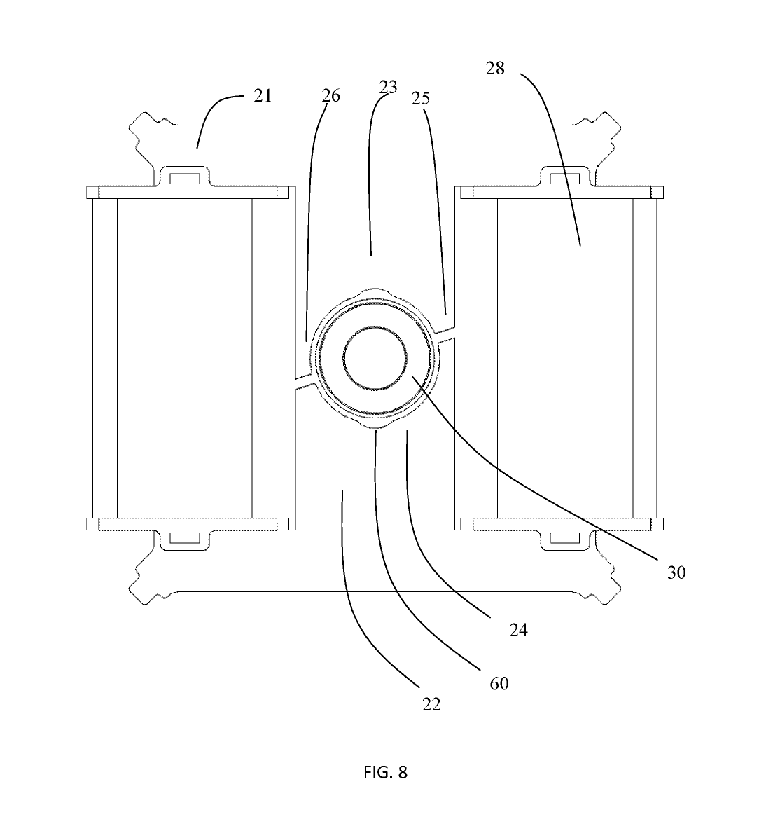

Referring to FIG. 8, in another embodiment of the present invention, the yoke 21 of the stator core is of a closed frame shape. Two teeth 22 extend from the yoke 21. The tooth 22 includes a tooth body 23 and a tooth tip 24 formed at a distal end of the tooth body 23. The tooth tip 24 includes a first pole shoe 25 and a second pole shoe 26 respectively located at opposite sides of the middle line of the tooth body 23 of the tooth. The rotor 30 is received in a space defined between the first pole shoes 25 and second pole shoes 26 of the two teeth 22. The stator core may be integrally formed, or may include several pieces separately formed and then assembled, e.g. by soldering or through mechanical connection. In this embodiment, the windings 28 are wound around the yoke 21. Alternatively, the windings 28 may be wound around the tooth bodies 23 of the teeth 22. The first and second pole shoes 25, 26 are asymmetrical about the central line of the tooth body 23 of the tooth 22 and the first pole shoe 26 is longer than the second pole shoe 25. The center of the locating groove 60 is aligned with the central line of the tooth body 23. In this embodiment, the stator tooth 22 is of a non-salient type, i.e. the pole shoes 25, 26 do not extend beyond two sides of the tooth body 23, but rather are hidden at the end of the tooth body 23.

This invention has a simple structure, large startup torque and large startup angle, which can effectively prevent the failure of producing the startup torque caused by the rotor 30 stopping at the “dead point” position, reduce the possibility of stopping at the startup dead point, as well as reduce the vibration and noise. In addition, bidirectional startup is achieved, which greatly enhances the startup reliability. The design of asymmetric pole shoes with different sizes makes the rotor have different bidirectional startup capabilities, which is especially suitable for applications having different requirements for bidirectional startup capabilities, such as power tools and car window lifters.

Although the invention is described with reference to one or more preferred embodiments, it should be appreciated by those skilled in the art that various modifications are possible. Therefore, the scope of the invention is to be determined by reference to the claims that follow.

1. A single phase brushless motor comprising:
a stator comprising a stator core and windings, the stator core comprising a yoke and a plurality of teeth extending inward from the yoke, the tooth comprising a tooth body and a tooth tip disposed at a distal end of the tooth body, the windings being wound around the stator core, the tooth tip comprising a first pole shoe and a second pole shoe located at opposite two sides of the tooth, respectively, the tooth tip forming a positioning groove; and
a rotor rotatable relative to the stator, the rotor being received in a space defined between the first pole shoes and the second pole shoes of the teeth, the positioning groove facing the rotor, the rotor comprising a plurality of permanent magnetic poles arranged in a circumferential direction of the rotor,
wherein the first pole shoe and the second pole shoe are asymmetrical about a central line of the tooth body, such that startup capability of the rotor in one direction is greater than startup capability of the rotor in an opposite direction.

2. The single phase brushless motor of claim 1, wherein each of the first and second pole shoes has a pole face facing the rotor, the positioning groove is located between the pole faces of the first pole shoe and the second pole shoe, and the pole face of the second pole shoe is greater than the pole face of the first pole shoe.

3. The single phase brushless motor of claim 2, wherein a length of the second pole shoe is greater than a length of the first pole shoe but less than two times of the length of the first pole shoe.

4. The single phase brushless motor of claim 1, wherein inner circumferential surfaces of the first pole shoe and the second pole shoe are located on a same cylindrical surface.

5. The single phase brushless motor of claim 1, wherein in the plurality of teeth, the second pole shoe of one tooth and the first pole shoe of another tooth are disposed adjacent each other with a slot opening or a magnetic bridge formed there between.

6. The single phase brushless motor of claim 5, wherein a gap is formed between inner circumferential surfaces of the first pole shoe and the second pole shoe and an outer surface of the rotor, and the width of the slot opening is greater than a thickness of the gap but less than a width of the positioning groove.

7. The single phase brushless motor of claim 1, wherein in a startup phase, a ratio of an average output torque of the rotor in the one direction to an average output torque of the rotor in the opposite direction is greater than 11:9.

8. The single phase brushless motor of claim 1, wherein a central line of the positioning groove is coincident with the central line of the tooth body.

9. The single phase brushless motor of claim 1, wherein a width of the positioning groove is equal to or greater than a width of the tooth body of the tooth.

10. The single phase brushless motor of claim 1, wherein radial thicknesses of the first pole shoe and the second pole shoe gradually decrease in directions away from the tooth body.

11. The single phase brushless motor of claim 1, wherein the yoke comprises a half-frame shaped yoke, a closed frame-shaped yoke or an annular yoke.

12. The single phase brushless motor of claim 1, wherein the rotor further includes a rotor core, and the permanent magnetic poles are formed by a permanent magnet mounted to a surface of the rotor core or permanent magnets embedded in the rotor core.

13. The single phase brushless motor of claim 1, wherein a startup angle of the rotor is greater than 40 degrees in electric angle.

14. An electric apparatus comprising a single phase brushless motor of claim 1.

15. The electric apparatus of claim 14 being a power tool.

16. The electric apparatus of claim 14 being a vehicle window lifter.
